(19) United States
(12) Patent Application Publication
(10) Pub. No.: US 2009/0241313 A1
(43) Pub. Date: Oct. 1, 2009

(54) Pin Removal and Insertion Tool

(76) Inventor: Robert L. Vess, Crozet, VA (US)

Correspondence Address: PARKER INTELLECTUAL PROPERTY LAW OFFICE, 536 PANTOPS CENTER, # 234, CHARLOTTESVILLE, VA, 22911, US

(21) Appl. No.: 12/059,827

(22) Filed: Mar. 31, 2008

(51) Int. Cl. B25B 27/04

(52) U.S. Cl. 29/275

(57) ABSTRACT

A tool for the removal and insertion of the retaining pins used to maintain teeth, or caps, on heavy equipment. The tool has an elongated body with the majority portion of the ends being angled and the remaining portion chamfered. A handle extends from the body and on the opposing side is a pin removal bar at right angles to the body which has a sufficient length to extend beyond the teeth. Preferably the pin removal bar is offset from the center of the body to position the pin removal bar proximate the tooth adjacent to the pin to be removed. A removal pin is affixed to the distal end of the pin removal bar and has a length slightly less than a distance between teeth.

### BACKGROUND

1. Field of the Invention

The present invention relates generally to a tool for the removal and insertion of the securing pins used to maintain the teeth, or caps, onto the bucket of digging equipment.

2. Related Art

Although several patents have issues on the removal of pins, few patents have issues on the removal and insertion of difficult-to-access heavy duty pins. Tools to remove the lighter weight pins have been disclosed in patents such as U.S. Pat. No. 1,355,174 to Shepard showing a cotter pin extractor tool that includes a pair of relatively pointed tip elements, one for spreading the tips and one for hooking the eye, for making contact with cotter pins, and an offset portion, between the tips, for receiving hammer blows for extracting the cotter pins.

U.S. Pat. No. 2,359,677 (Reeves) discloses an impact tool for removing detachable drill bits from a shaft. The apparatus includes a working end offset from the impacting portion. The impacting portion includes a relatively long shaft and a circular or enlarged end, while the working end is illustrated in several different embodiments. The working end is offset from the shaft and the enlarged portion.

U.S. Pat. No. 2,860,408 (Woyton) discloses a muffler tail pipe removing tool which includes an elongated handle, a blade portion which is substantially perpendicular to the elongated handle, and an impact striking portion adjacent to the blade portion, but offset from and generally parallel to the blade portion. The impact portion is secured to the handle.

U.S. Pat. No. 3,290,769 (Kashergen) discloses a tool used to change a digging tooth by the camming action of a bifurcated arm. The tool includes a handle, with an impact surface at the end of the handle. The handle and the impact or striking face is offset from the bifurcated arm. The bifurcated arm is of varying techniques to provide the camming action as the tool is driven by the impact from a hammer for removing the digging tooth.

U.S. Pat. No. 4,185,372 (Dupree et al) discloses an impact device for removing a key from a keyway. The tool or device includes a striking face which is parallel to, but offset from, the key removal portion.

U.S. Pat. No. 4,501,079 (Hahn et al) discloses a multiple cutting edge tool which includes pins and tools for removing and inserting the pins. The tool may be inverted for different uses. There is an impact surface that is parallel to the line of the tool, but offset from the actual working portion of the tool, regardless of whether the tool is inverted or not.

A pin insertion and removal device is disclosed in U.S. Pat. No. 5,058,257 (Freestone et al) that has a body, a handle and a pin removal area. The Freestone et al device is, however, awkward and heavy to use. The impact area of the Freestone et al patent is angled, thereby directing the pressure exerted by the hammer downward toward the tooth surface rather than parallel to the tooth's surface. Additionally, the extractor pin is cast with the body of the tool, thereby requiring that a new tool be purchased for the removal of the larger pins used with the large equipment.

A pin removal and placement tool is disclosed in U.S. Pat. No. 6,883,221 (Hayes III) that has a plate steel body member having a contact surface, a rear edge and optional anvil plate mounted on a striking plate. A handle extends at a right angle from the body. The tool is dimensioned to facilitate its insertion between the teeth of buckets, etc.

A retaining pin and keeper are disclosed in U.S. Pat. No. 5,009,017 (Diekevers, et al), however the removal or insertion of the pin is not addressed.

With respect to the insertion and removal of pins for the teeth and shanks of ground engaging equipment, the prior art predominately consists of pliers, such as “vise-grip” types for insertion, a drift punch of some type, and a hammer. A couple of tools have been directed specifically to the removal of pins from the teeth and shanks of equipment, however, these tools do not easily and safely remove the pins with a tool that is economical to manufacture and efficient to use.

### SUMMARY OF THE INVENTION

A tool for the removal and insertion of the retaining pins used to maintain teeth, or caps, onto heavy equipment. The tool has an elongated body with the majority portion of the ends being angled and the remaining portion chamfered. Preferably the body of the tool has a length sufficient to span adjacent teeth. The handle extends from the body at approximately right angles. On the opposing side of the body from the handle is a pin removal bar. The pin removal bar is at right angles to the body and has a sufficient length to extend beyond the pins. Preferably the pin removal bar is offset from the center of the body to position the pin removal bar proximate the tooth adjacent to the pin to be removed. A removal pin is affixed to the distal end of the pin removal and has a length slightly less than a distance between teeth.

The handle can be affixed to the body through any means desirable and can be welded or removably mounted through the use of threads. The pin removal bar can also be removably affixed to the body. It is preferable that the pin removal bar has a threaded receiving area to receive a threaded removal pin.

The receiving area preferably has a depth less than the threading on the removal pin to prevent damage to the threads. A dimple can be placed on the pin removal bar on the opposite side from the removal pin.

To remove the pins from the tooth, the handle is grasped and the body of the tool placed on adjacent teeth. The pin removal bar is positioned proximate the tooth adjacent to the tooth to be removed and the removal pin aligned with the end of the pin. The end of the body is then struck, forcing the removal to push the pin from the tooth. The removal pin and tool are then removed and the pin slipped from the tooth.

To insert pins into the tooth, the pin is first placed into the receiving area of the shank and tooth. The tool is placed on adjacent teeth and the dimple on the pin removal bar placed adjacent to the pin. The end of the tool is then struck and the pin forced into the tooth and shank. The pin removal bar is then rotated slightly to bring the pin flush with the surface.

### BRIEF DESCRIPTION OF THE DRAWINGS

FIG. 1 is a side view of the pin remover in accordance with the invention;

FIG. 2 is an end view of the body of the pin remover in accordance with the invention;

FIG. 3 is a side view of an alternate striking pin for use with the tool in accordance with the invention;

FIG. 4 is a side view of the tool positioned to remove a pin in accordance with the invention;

FIG. 5 is a side view of the position of the tool after partial removal of the pin in accordance with the invention; and

FIG. 6 is a side view of the disclosed tool being used to insert a pin in accordance with the invention.

### DETAILED DESCRIPTION OF THE INVENTION

Ground engaging equipment having excavator buckets and blades use teeth to break up and penetrate the material being dug up prior to the material being scooped up into the bucket. There are a number of specialized teeth that are sold by companies such as Caterpillar, for example teeth for penetration, soil digging, long tip, and twin sharp tips. These tips are mostly interchangeable with several different styles of teeth being able to be used on a single piece of equipment. Additionally, as the teeth wear, they must be turned or replaced with an identical or different style of tooth. Turning periodically extends the life of the teeth thereby dramatically reducing the cost by tooth replacement . . . .

The teeth are attached to the bucket through the use of pins that interact with shanks extending from the edge of the buckets, cutting edges or ripper shank. At one side of the shank is a friction locking ring, or other mechanism, commonly known as a keeper, which maintains the pin in place. To release the pin, the locking between the keeper and the pin must be dislodged. The pins are placed at approximately the edge of the tooth and are therefore not easily accessible. This presents a problem in that the teeth are spaced only several inches apart, thereby preventing easy access to the pins. To remove the pin safely from the shank, the striking pin must contact the pin on the same plane and therefore must be placed below the accessible surface of the tooth.

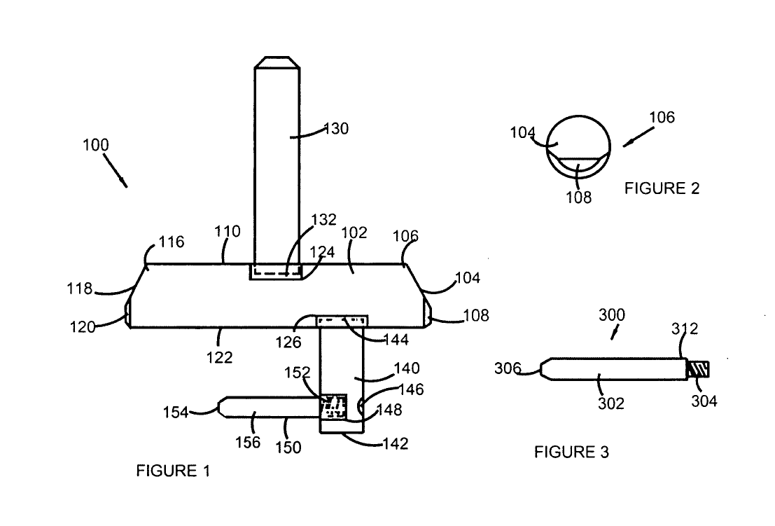

FIG. 1 illustrates the pin removal tool 100 which, as shown, consists of an elongated body 102, a handle 130 and a pin removal bar 140. The body 102 in the illustrated embodiment is round, however other configurations, such as squares, ovals, rectangles, can also be used

The ends 106 and 116 have a portion of the striking surface beveled to form beveled striking surface 104 and beveled striking surface 118. A chamfered area 108 is placed below beveled striking surface 104 and a chamfered area 120 placed below beveled striking surface 118. The angle at which the beveled striking surface 104 and beveled striking surface 118 are cut is not critical, however the beveling is required to avoid the ends 106 and 116 from mushrooming. The repeated striking of a flat surface will cause the surface to expand and curl at the unsupported edges. The curled metal then can fragment and cause injury. By beveling the ends 106 and 116, to create beveled surfaces 104 and 118, this expansion is minimized. It should be noted that the chamfering 108 can also extend around the periphery of the ends 104 and 118 to almost eliminate mushrooming.

The body further comprises a handle 130 extending midway between the beveled surfaces 104 and 118 to place it in the center of the body 102 for balance and ease of use. The handle 130 extends at right angles to the top body surface 110 a sufficient distance to enable a user to easily grip and hold the device 100. The proximal end 132 of the handle 130 is welded by placement into the handle recess 124 created within the body 102. The handle could also be threaded and placed into a threaded recess within the body. Alternatively the entire body can be cast as a single piece. It should also be noted that the entire tool, or only parts thereof, can be cast as a single unit.

On the under side 122 of the body 102 is the pin removal bar 140 that accepts the striking pin 150 or striking pin 302 (FIG. 3) depending upon the size of the pin and tooth being removed or installed. The pin removal bar 140 is preferably square or rectangular in shape and welded into the pin removal bar recess 126 on the direct opposite side of the body from the handle 130 positioned along the length of the body 102 to provide optimum balance. The pin removal bar 140 must extend at right angles to the under side 122 of the body 102 in order to place the striking pin 150 parallel to the body to remove the pin from the tooth. The length of the pin removal bar 140 is preferably slightly greater than the distance between the surface of the tooth and the location of the pin maintaining the tooth in position. Preferably the length of the pin removal bar 140 is slightly greater than the distance from the top of the tooth to the pin of the largest piece of equipment manufactured, however different size tools can be made with varying pin removal bar lengths. The pin removal bar 140 can also be cast as part of the body 102.

In the preferred embodiment the body 102 is round to enable the pin removal tool 100 to accommodate different sizes of equipment. The preferred dimensions of the tool 100, set forth hereinafter, are such that the removal tool 100 can accommodate the larger equipment, although other dimensioning will be apparent to those skilled in the art when read in conjunction with this disclosure. By having the body 102 round, the body 102 can be rolled to adjust the distance between the top of the tooth and the striking pin 150. This enables the pin removal tool 100 to be used for various sized equipment and eliminates the need to purchase multiple tools, with only different size and length removal pins being required.

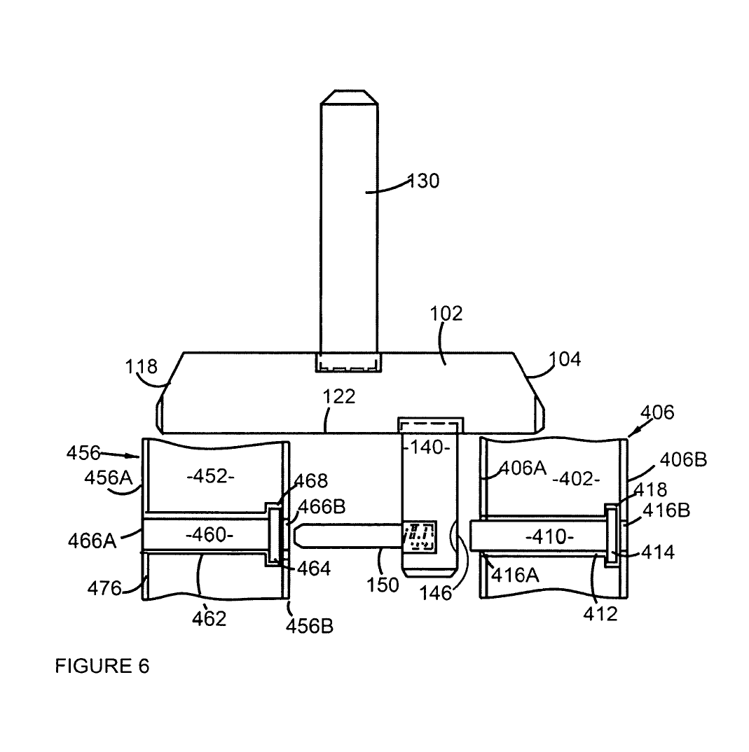

As can be seen in FIGS. 1 and 4-6, the pin removal bar 140 is offset from the center of the body 102 to enable the body 102 to rest on the surface of the teeth 406 and 456, one of which carries the pin 460 to be removed. The combined length of the striking pin 150 and width of the pin removal bar 140 must be less than the distance between the teeth 456 and 406 to enable the striking pin 150 to be placed on the same plane as the pin. The pin removal bar 140 has a threaded receiving area 148 to receive the striking removal pins 150 and 302 (FIGS. 1 and 3). Although the placement of the receiving area 148 is not critical with respect to the bottom of the pin removal bar, it must not be placed so near the distal end 142 as to compromise structural strength. The placement, however, of the receiving area 148 with respect to the body underside 122 is critical. The receiving area 148 must also be far enough toward the distal end 142 to enable the striking pin 150 to be on the same plane and adjacent to the pin 460 to be removed. On the opposite side of the pin removal bar 140 is an insertion dimple 146 which is, as described hereinafter, used to insert the pins.

The striking pin 150 has a threaded proximal end 152 that is dimensioned to be received in the receiving area 148 of the pin removal bar 140. The threaded proximal end 152 is the same dimension as the body 156 and preferably has a length equal to, or slight greater than the depth of the receiving area 148. By dimensioning the threaded proximal end 152 to bottom out within the receiving area 148, the pressure exerted when removing a pin 460 is transferred through the end of the proximal end 152 to the pin removal bar 140 rather than being absorbed by the threads. This prevents the threads from being stripped during repeated use. Alternatively the striking pin 150 can be welded to, or cast with, the pin removal bar 140, however that would eliminate the ability to change striking pin sizes as described hereinafter and to eliminate the need for multiple tools 100. The distal end 154 of the striking pin 150 is chamfered to provide leeway in alignment; however the body 156 of the striking pin 150 is dimensioned slightly less than that of the inside diameter of the keeper 464 from which the pin 460 is being removed.

In FIG. 2, the end 106 is illustrated showing the beveled striking surface 104 and chamfered area 108 which, as noted heretofore, can be around the periphery of the ends 108 and 118. As stated heretofore, the use of the beveled and chamfered design greatly reduces the mushrooming affect caused by metal expansion.

A larger striking pin 300 is illustrated in FIG. 3 designed to accommodate the larger and more spaced teeth used on larger equipment. As can be seen in this embodiment, the body 302 has a greater diameter than the threaded proximal end 304, thereby creating a shoulder 312. The shoulder 312 not only makes manufacturing easier but also helps spread the pressure exerted in removing the larger pins. In this design, a portion of the pressure is transferred directly to the pin removal bar 140 through the shoulder 312 as well as through the bottoming out of the threaded proximal end 304 within the receiving area 148. The diameter and threads of the threaded proximal end 304 of this embodiment preferably remains the same as the threaded proximal end 152 of the striking pin 150 to enable the use of a single tool 100 for both striking pins 150 and 300. The striking pin 300 also has the chamfered distal end 306 as described in conjunction with the striking pin 150 heretofore.

It should be noted that for ease of description only two teeth, 406 and 456 are being referenced. Additionally, the description is directed to the removal of the pin 460 in tooth 456 and the insertion of pin 410 into tooth 406. It will be obvious to anyone skilled in the art that this is not limiting to the invention and any pin in any tooth can be removed or inserted as described.

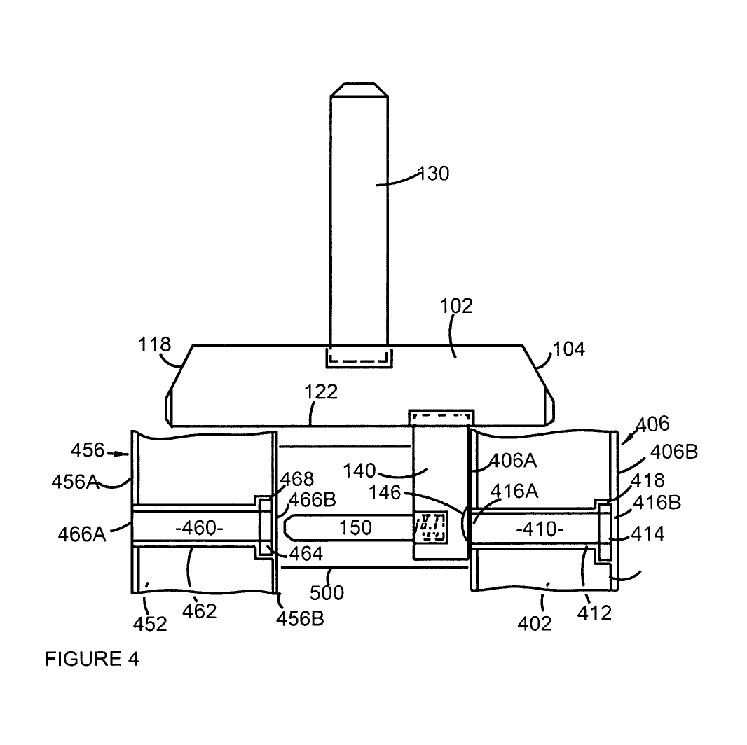

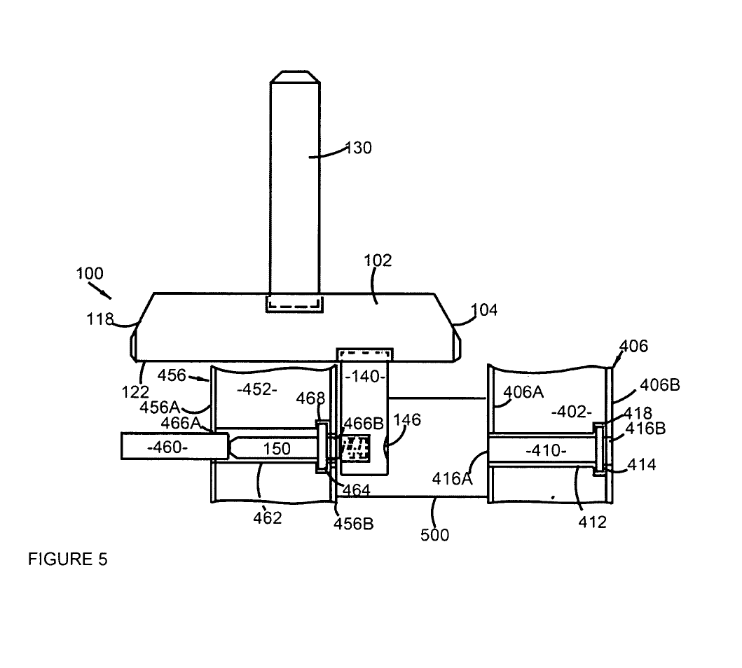

The removal of the pin 460 from the tooth 456 and shank 452 is illustrated in FIGS. 4 and 5. As known in the art, the teeth 406 and 456 are placed over the shanks 402 and 452, which are bolted or welded to a cutting edge of the equipment 500. The teeth 406 and 456 are maintained on the shanks 402 and 452 respectively by pins 410 and 460. The pins 410 and 460 are maintained in place by being slid through ports 416A and 466A within the sides 406A and 456A of the teeth 406 and 456, through the shank channels 412 and 462 to the keepers 414 and 464. The keepers 414 and 464 are placed in keeper receiving areas 418 and 468 located at the end of the shank channels 412 and 462. The keepers 414 and 464 are dimensioned to receive and retain the pins 410 and 460. The keepers 414 and 464 lock the pins 410 and 460 in place by means known in the art. To release the pin 460, the connection between the pin 460 and the keeper 464 must be dislodged. Using the disclosed tool 100, the user, holding the handle 130, slides the pin removal bar 140 between the teeth 406 and 456, adjacent to the tooth side 406A, and positions the striking pin 150 adjacent to the pin 460. The striking area 104 is hit with a hammer (not shown), horizontally sliding the bottom edge 122 of the body 102 along the teeth 406 and 456 and forcing the striking pin 150 to contact the pin 460 through port 466B. When removing pin 410, the process would be the same as set forth above with the striking pin 150 contacting pin 410 through port 416B at the tooth side 406B. The impact of the striking pin 150 forces the pin 460 out of the keeper 464 to the position illustrated in FIG. 5 wherein the motion of the pin removal bar 140 is stopped as it contacts the tooth side 456B. The device 100 is then slid back the necessary distance to permit removal of the tool 100 once the striking pin 150 is cleared. As the pin 460 is maintained in place by the keeper 464, once that contact is broken, the pin 460 can then be removed from the shank 452 and tooth 456 by hand or gripping tools.

To install and seat the pin 410 into a tooth 406, the pin 410 is inserted through the port 416A at tooth side 406A and into the channel 412 until it contacts, or comes close to contacting, the keeper 414. This can generally be done by hand, however if the channel 412 is slightly coated with dirt, etc., the pin 410 can require additional force. The insertion dimple 146 can be used to insert the pin 410 and used to prevent the pin 410 from slipping while striking the striking area 118 with a hammer. When the dimple 146 is used, however, the pin 410 will not be fully seated within the keeper 414. As the pin 410 must be fully inserted into the keeper 414 in order to be flush with the tooth side 406A, a small portion of the pin 410 is exposed when initially inserted. The tool 100 is inserted by placing the insertion dimple 146 adjacent to the exposed end of the pin 410 and then rotated slightly on the teeth 406 and 456. The rotation places the flat surface of the pin removal bar 140 adjacent to the exposed portion of the pin 410. The striking area 118 is hit with a hammer (not shown) thereby forcing the pin 410 to be fully seated within the keeper 414 and bringing it flush with the tooth side 406A.

### CONSTRUCTION EXAMPLE

Although the following examples are not intended to limit the scope of the invention, they will provide guidelines for manufacture.

The handle 130 can be manufactured from about one (1) inch round steel stock and be about five and one quarter (5.25) inches long. The length is not critical, however as the steel is heavy lengthening the handle 130 adds weight without any benefit to the user and restricts the placement of the tool in the equipment tool boxes. Most pieces of equipment have tool boxes that are designed to hold tools and parts relating to the specific piece of equipment. The above dimensions will enable the disclosed tool 100 to be maintained in the standard equipment tool boxes.

The body 102 is manufactured from one and one half (1.5) inch round steel stock and approximately seven (7) inches long. The body 102 can be longer, however this adds weight and will restrict the areas in which the tool can be stored. The body 102 has a pair of one (1) inch beveled surfaces 104 and 118 at approximately a 45 degree angle. This leaves one half (0.5) inch areas 108 and 120 that are then preferably chamfered. The receiving area 124 for the handle 130 is recessed approximately one quarter (0.25) inch at the mid-point of the body 102. On the opposing side of the body 102 the removal bar recess 126 is formed at approximately one quarter (0.25) inch. The removal bar recess 126 is distanced approximately one and one half (1.5) inches from the area 108.

The removal bar 140 is approximately one (1) inch square stock with threaded receiving area 148 having a centerline of approximately two (2) inches from the proximal end 144. The threaded receiving area 148 is approximately one half (0.5) inch deep with a diameter of three eights (0.375) inch. It is easier to coordinate the diameter of the receiving area 148 with the diameter of the striking pins 150 and 300 than the reverse. This allows for standard stock to be used for the striking pins 150 and 300.

The striking pins 150 and 300 are manufactured from standard stock, or bolts, with a three eights (3.75) inch thread. Striking pin 150 is approximately two and one quarter (2.25) inches long with a three eights (0.375) inch diameter. Striking pin 300 is approximately four (4) inches long with a one half (0.5) inch diameter body and a ⅜ diameter threaded area. The threaded areas on the striking pins 150 and 300 are preferably at least one half (0.5) inch long to enable them to bottom out against the pin removal bar 140 as described heretofore.

### BROAD SCOPE OF THE INVENTION

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language of the present invention or inventions should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example.”

ELEMENT LIST

| | |
|---|---|
| 100 | pin removal tool |
| 102 | body |
| 104 | beveled surface for striking |
| 106 | end |
| 108 | chamfered striking area |
| 110 | top body surface |
| 116 | end |
| 118 | beveled surface for striking |
| 120 | chamfered striking area |
| 122 | body under side |
| 124 | handle recess |
| 126 | pin removal bar recess |
| 130 | handle |
| 132 | proximal end |
| 140 | pin removal bar |
| 142 | distal end |
| 144 | proximal end |
| 146 | insertion dimple |
| 148 | threaded receiving area |
| 150 | small striking removal pin |
| 152 | proximal end |
| 154 | distal end |
| 156 | body |
| 300 | larger striking removal pin |
| 302 | body |
| 304 | threaded proximal end |
| 306 | chamfered distal end |
| 312 | shoulder |
| 402 | shank |
| 406 | tooth |
| 406A | tooth side |
| 406B | tooth side |
| 410 | pin |
| 412 | shank channel |
| 414 | keeper |
| 416A | port |
| 416B | port |
| 418 | keeper receiving area |
| 452 | shank |
| 456 | tooth |
| 456A | tooth side |
| 456B | tooth side |
| 460 | Pin |
| 462 | shank channel |
| 464 | keeper |
| 466A | port |
| 466B | port |
| 468 | keeper receiving area |
| 500 | equipment |

What is claimed is:

1. A tool for the removal and insertion of retaining pins used to maintain teeth onto the shanks of heavy equipment having:
a. an elongated body, said elongated body having two striking ends,
b. a handle, said handle being affixed to said body at approximately right angles,
c. a pin removal bar, said pin removal bar being affixed at a right angle to said body, on approximately the opposing side to said handle, at its proximal end and having a length sufficient to position said distal end beyond said pin in said teeth,
d. a removal pin, said removal pin being affixed to said pin removal bar at a distal end and having a length slightly less than a distance between said teeth when affixed to said pin removal bar.

2. The tool of claim 1 wherein said body has a length sufficient to lay on adjacent teeth.

3. The tool of claim 1 wherein a portion of said striking ends is angled.

4. The tool of claim 3 wherein a portion of said striking ends is chamfered.

5. The tool of claim 1 wherein said handle is removably affixed to said body.

6. The tool of claim 1 wherein said pin removal bar is removably affixed to said body.

7. The tool of claim 1 wherein said pin removal bar further comprises a receiving area to receive said removal pin.

8. The tool of claim 8 wherein said receiving area is threaded to receive a threaded removal pin.

9. The tool of claim 8 wherein said receiving area has a depth equal to or less than the threads of said removal pin to prevent damage to said threads.

10. The tool of claim 1 wherein said pin removal bar further comprises a dimple, said dimple being on an opposing side from said removal pin.

11. The tool of claim 1 wherein said pin removal bar is offset from a center point of said body to enable said pin removal bar and said removal pin to be inserted between said teeth while said body lies on said teeth.

12. The tool of claim 1 wherein said body has a length sufficient to lay on adjacent teeth and a first portion of said striking ends is angled and a second portion of said striking ends is chamfered.

13. The tool of claim 1 wherein said pin removal bar is offset from said handle to enable said pin removal bar and said removal pin to be inserted between said teeth while said body lies on said teeth and further comprises a threaded receiving area to receive a removal pin having a threaded end, said threaded end of said removal pin contacting the back of said threaded receiving area and a dimple on an opposing side from said removal pin.

14. The tool of claim 1 wherein said body is one and one half (1.5) inch round steel stock approximately seven (7) inches long; each of said striking ends being beveled along one (1) inch at approximately a 45 degree angle and chamfered at one half (0.5) inch; a receiving area said handle is recessed approximately one quarter (0.25) inch at the mid-point of said body; a recess for said removal bar being approximately one quarter (0.25) inch distanced approximately one and one half (1.5) inches from one of said ends; said removal bar is approximately one (1) inch square; a threaded receiving area is approximately one half (0.5) inch deep with a diameter of three eights (0.375) inch; said removal pin has a three eights (0.375) inch diameter and a three eights (3.75) inch thread.

15. The method of removing pins from the tooth positioned on a shank of equipment using a tool, comprising the steps of:
a. grasping the handle of said tool;
b. placing the body of said tool on adjacent teeth;
c. positioning said body to place a pin removal bar proximate the tooth adjacent the tooth to be removed;
d. aligning a removal pin extending at 90 degrees from said pin removal bar with an end of said pin;
e. striking an end of said body toward said pin for removal;
f. forcing said pin out from a channel in said shank and said tooth with said removal pin;
g. removing said removal pin and said tool;
h. removing said pin from said shank and said tooth;
i. removing said tooth from said shank.

16. The method of inserting pins into the tooth positioned on a shank of equipment using a tool comprising the steps of:
a. placing said tooth on said shank;
b. aligning receiving holes in said tooth with a channel in said shank;
c. inserting a pin into said tooth and through said channel;
d. grasping the handle of said tool;
e. placing the body of said tool on adjacent teeth;
f. positioning said body to place a pin removal bar proximate the pin to be inserted;
g. striking an end of said body toward said pin;
h. forcing said pin into said channel with said pin removal bar;
i. removing said removal pin and said tool.

17. The method of claim 16 wherein a dimple on said removal bar is used to align said pin removal bar with said pin.

18. The method of claim 17 wherein after insertion of said pin, said pin removal bar is rotated to place a flat surface adjacent to said pin to bring said pin flush with said tooth.
